(19) United States
(12) Patent Application Publication
(10) Pub. No.: US 2026/0194682 A1
(43) Pub. Date: Jul. 9, 2026

(54) METHOD AND DEVICE FOR DETERMINING STRATUM APPARAENT RESISTIVITY BASED ON ANTI-SYMMETRIC SQUARE WAVE

(71) Applicant: INSTITUTE OF GEOLOGY AND GEOPHYSICS, CHINESE ACADEMY OF SCIENCES, BEIJING CITY (CN)

(72) Inventors: PENGFEI LIANG, BEIJING CITY (CN); QINGYUN DI, BEIJING CITY (CN); WENXIU ZHANG, BEIJING CITY (CN); WENXUAN CHEN, BEIJING CITY (CN)

(21) Appl. No.: 19/014,236

(22) Filed: Jan. 9, 2025

(51) Int. Cl. G01V 3/38; G01V 3/08

(52) U.S. Cl. CPC G01V 3/38; G01V 3/087

(57) ABSTRACT

A method and a device for determining a stratum apparent resistivity based on an anti-symmetric square wave, which include: acquiring a first time-domain signal observed by a detection instrument in a predetermined homogeneous model and a second time-domain signal observed in a target stratum, the first time-domain signal and the second time-domain signal being obtained by the detection instrument observing an anti-symmetric square wave excitation source; determining first magnetic field distribution information corresponding to the predetermined homogeneous model based on the first time-domain signal, and determining second magnetic field distribution information corresponding to the target stratum based on the second time-domain signal; and acquiring a full-zone apparent resistivity of a target stratum through an iterative algorithm based on the first magnetic field distribution information and the second magnetic field distribution information.

### FIELD OF THE DISCLOSURE

The present disclosure relates to the technical field of geological exploration technologies, and more particularly to a method and device for determining a stratum apparent resistivity based on an anti-symmetric square wave.

### BACKGROUND OF THE DISCLOSURE

Transient electromagnetic instruments are geophysical exploration devices that utilize the principle of electromagnetic induction to investigate the conductivity of subsurface materials. In terms of this technology, a single square wave pulse is typically used as the excitation source to transmit a brief electromagnetic signal underground. A square wave pulse is a waveform that rapidly transitions from zero to its maximum value and back to zero within a short period. When such signal propagates in the underground medium, different responses may be produced due to different conductivities of the medium.

Since the spectrum of a square wave pulse is very broad, it encompasses all frequencies from high to low. This broadband characteristic means that the radiated electromagnetic energy is distributed across various frequencies, with the energy levels at different frequencies being uneven. This distribution of energy makes transient electromagnetic signals highly susceptible to various types of noise during propagation. These include noise from a drill collar, circuitry, and environmental factors. The presence of such noise and interference significantly reduces the accuracy of extracting stratum information from the observed signals.

### SUMMARY OF THE DISCLOSURE

The present disclosure provides a method and a device for determining a stratum apparent resistivity based on an anti-symmetric square wave, aiming to address at least one of the aforementioned technical issues.

The present disclosure provides a method for determining a stratum apparent resistivity based on an anti-symmetric square wave, including:
acquiring a first time-domain signal observed by a detection instrument in a predetermined homogeneous model and a second time-domain signal observed in a target stratum, wherein the predetermined homogeneous model refers to a model with a predetermined fixed conductivity value, and the first time-domain signal and the second time-domain signal are obtained by the detection instrument observing an excitation source of the anti-symmetric square wave; a current waveform corresponding to the excitation source of the anti-symmetric square wave has equal magnitude but opposite directions in positive and negative half-cycles, and an equal duration;
determining first magnetic field distribution information corresponding to the predetermined homogeneous model based on the first time-domain signal, and determining second magnetic field distribution information corresponding to the target stratum based on the second time-domain signal; and
acquiring a full-zone apparent resistivity of the target stratum through an iterative algorithm based on the first magnetic field distribution information and the second magnetic field distribution information.

The present disclosure further provides a device for determining a stratum apparent resistivity based on an anti-symmetric square wave, including:
an acquisition module, configured to acquire a first time-domain signal observed by a detection instrument in a predetermined homogeneous model and a second time-domain signal observed in a target stratum, wherein the predetermined homogeneous model refers to a model with a predetermined fixed conductivity value, and the first time-domain signal and the second time-domain signal are obtained by the detection instrument observing an excitation source of the anti-symmetric square wave; a current waveform corresponding to the excitation source of the anti-symmetric square wave has equal magnitude but opposite directions in positive and negative half-cycles, and an equal duration;
a determination module, configured to determine first magnetic field distribution information corresponding to the predetermined homogeneous model based on the first time-domain signal, and determine second magnetic field distribution information corresponding to the target stratum based on the second time-domain signal; and
a computation module, configured to acquire a full-zone apparent resistivity of the target stratum through an iterative algorithm based on the first magnetic field distribution information and the second magnetic field distribution information.

The method and the device for determining a stratum apparent resistivity based on an anti-symmetric square wave provided by the present disclosure include: acquiring the first time-domain signal observed by the detection instrument in the predetermined homogeneous model and the second time-domain signal observed in the target stratum, wherein the predetermined homogeneous model refers to the model with the predetermined fixed conductivity value, and the first time-domain signal and the second time-domain signal are obtained by the detection instrument observing the excitation source of the anti-symmetric square wave; the current waveform corresponding to the excitation source of the anti-symmetric square wave has equal magnitude but opposite directions in the positive and negative half-cycles, and the equal duration; determining the first magnetic field distribution information corresponding to the predetermined homogeneous model based on the first time-domain signal, and determining the second magnetic field distribution information corresponding to the target stratum based on the second time-domain signal; and acquiring the full-zone apparent resistivity of the target stratum through the iterative algorithm based on the first magnetic field distribution information and the second magnetic field distribution information. The present disclosure leverages differences in the duration of the anti-symmetric square wave excitation source to excite electromagnetic fields with varying central frequencies, so as to achieve detection of stratums at different depths. Under identical conditions, utilizing anti-symmetric square wave excitation sources with varying durations results in stronger magnetic signal intensity and higher signal-to-noise ratios and facilitates longer-range detection and enables precise exploration of distant stratum boundaries.

### BRIEF DESCRIPTION OF THE DRAWINGS

To provide a clearer explanation of the technical solutions of the present disclosure or the prior art, the figures used in the description of the embodiments or prior art are briefly introduced below. It is evident that the following figures depict some embodiments of the present disclosure. For those skilled in the art, other figures may be obtained based on these figures without creative efforts:

FIG. 1 is schematic flowchart of a method for determining a stratum apparent resistivity based on an anti-symmetric square wave provided by the present disclosure;

FIG. 2 is a waveform diagram of an excitation source of the anti-symmetric square wave according to an embodiment of the present disclosure;

FIG. 3 is a schematic diagram of a magnetic field spectrum radiated by the excitation source according to an embodiment of the present disclosure;

FIG. 4 is a waveform diagram of a single square wave excitation source in prior art provided by the present disclosure;

FIG. 5 is a schematic diagram of a magnetic field spectrum radiated by the single square wave excitation source in prior art provided by the present disclosure;

FIG. 6 is schematic structural diagram of a device for determining a stratum apparent resistivity based on an anti-symmetric square wave provided by the present disclosure; and

FIG. 7 is a schematic structural diagram of an electronic device provided by the present disclosure.

### DETAILED DESCRIPTION OF THE EXEMPLARY EMBODIMENTS

To make the objectives, technical solutions, and advantages of the present disclosure clearer, the technical solutions of the present disclosure will be described in detail below in conjunction with the accompanying drawings. It is evident that the described embodiments are part of the embodiments of the present disclosure, not all of them. Based on the embodiments in the present disclosure, all other embodiments obtained by those skilled in the art without any creative effort shall fall within the protection scope of the present disclosure.

In one or more embodiments of the present disclosure, the terms used are merely for describing specific embodiments and are not intended to limit one or more embodiments of the present disclosure. In one or more embodiments of the present disclosure, the singular forms “a,” “the,” and “this” are also intended to include plural forms unless the context clearly indicates otherwise. It should also be understood that the term “and/or” as used in one or more embodiments of the present disclosure refers to and includes all possible combinations of one or more of the listed items.

It should be understood that although the terms “first,” “second,” etc., may be used in one or more embodiments of the present disclosure to describe various pieces of information, such information should not be limited by these terms. These terms are only used to distinguish one piece of information from another of the same type. For example, “first” may be referred to as “second” without departing from the scope of one or more embodiments of the present disclosure, and similarly, “second” may also be referred to as “first.” Depending on the context, the term “if” as used herein may be interpreted as “when” or “upon.”

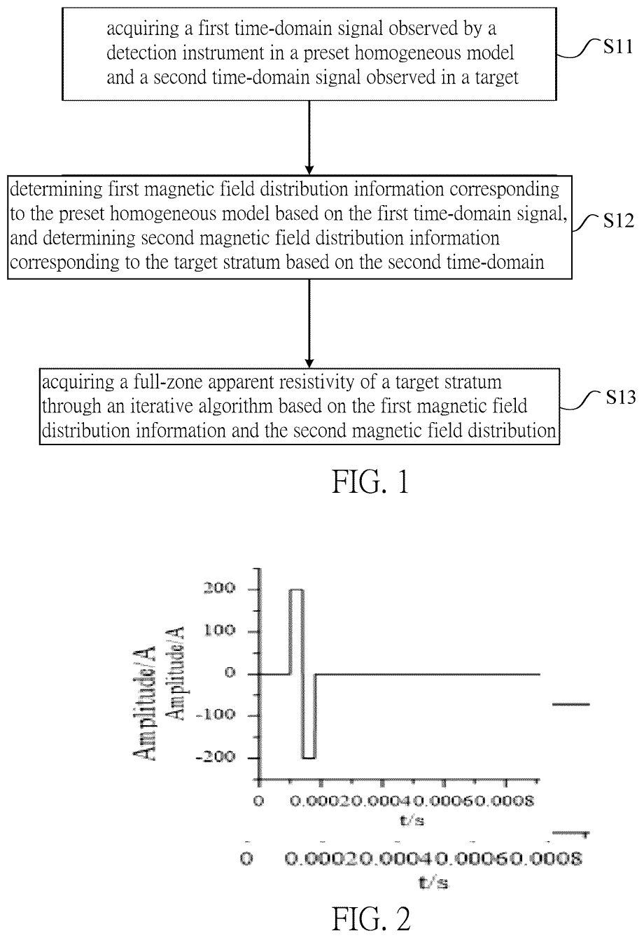

FIG. 1 illustrates a flow diagram of a method for determining a stratum apparent resistivity based on an anti-symmetric square wave provided by the present disclosure. As shown in FIG. 1, the method includes:
Step S11: acquiring a first time-domain signal observed by a detection instrument in a predetermined homogeneous model and a second time-domain signal observed in a target stratum.

It should be noted that the predefined homogeneous model refers to a model with a predetermined fixed conductivity value, such as an air model. It should be understood that the detection instrument is suspended in the air layer for observation, and the observed signal reflects the propagation characteristics of electromagnetic waves in the air. This signal can be used to correct data observed in the stratum by accounting for interference caused by factors outside the underground medium (e.g., drill collars).

It is also worth noting that the second time-domain signal refers to data detected by a receiving antenna in a target stratum after electromagnetic waves propagate through the underground medium. This signal contains electrical information about the underground medium but may also be affected by electromagnetic interference caused by metallic objects such as drill collars. The detection instrument uses the same excitation source for surveys conducted in both the air layer and the unknown target stratum.

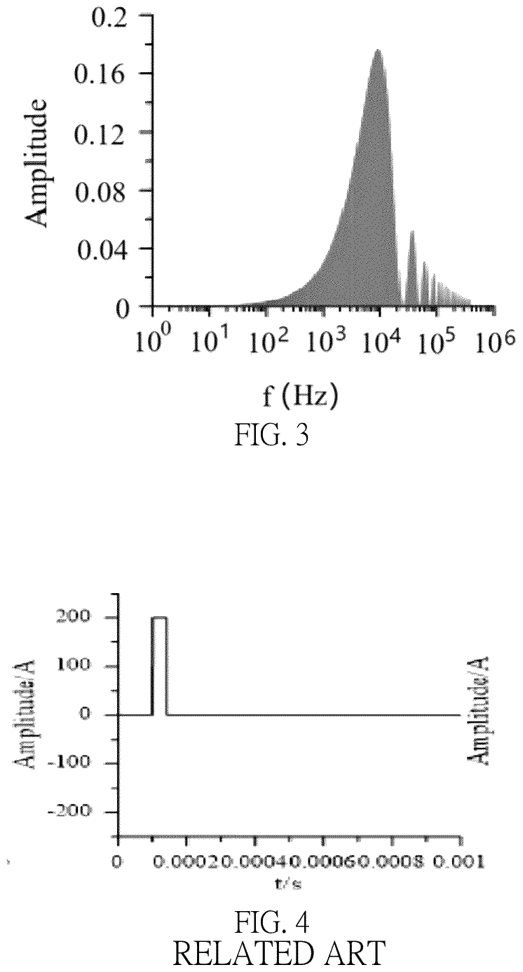

Additionally, the first time-domain signal and the second time-domain signal are obtained by the detection instrument observing an anti-symmetric square wave excitation source. The current waveform of the anti-symmetric square wave excitation source has equal magnitudes but opposite directions in the positive and negative half-cycles, with equal durations. Referring to FIG. 2, FIG. 2 illustrates a waveform diagram of the excitation source of the anti-symmetric square wave provided in an embodiment of the present disclosure. In FIG. 2, the current duration of the excitation source is 0.0001 s. As shown in FIG. 3, FIG. 3 is a schematic diagram of the magnetic field spectrum radiated by the excitation source provided in an embodiment of the present disclosure. For the predetermined homogeneous model, FIG. 3 shows that a center frequency of the spectrum is close to 100 kHz, and a bandwidth is narrow.

The current expression for the excitation source of the anti-symmetric square wave is as follows.

$$I = - {I}_{1} + {I}_{2} - {I}_{3} + {I}_{4} \\ {I}_{1} = \{ \begin{matrix}{I}_{0} , time \leq 0 \\ 0 , time > 0\end{matrix} {I}_{2} = \{ \begin{matrix}{I}_{0} , time \leq {t}_{1} \\ 0 , time > {t}_{1}\end{matrix} \\ {I}_{3} = \{ \begin{matrix}- {I}_{0} , time \leq {t}_{1} \\ 0 , time > {t}_{1}\end{matrix} \\ {I}_{4} = \{ \begin{matrix}- {I}_{0} , time \leq {t}_{2} \\ 0 , time > {t}_{2}\end{matrix}$$

In another embodiment, the current expression for the excitation source of the anti-symmetric square wave is as follows.

$$I = {I}_{1} - {I}_{2} + {I}_{3} - {I}_{4} \\ {I}_{1} = \{ \begin{matrix}{I}_{0} , time \leq 0 \\ 0 , time > 0\end{matrix} {I}_{2} = \{ \begin{matrix}{I}_{0} , time \leq {t}_{1} \\ 0 , time > {t}_{1}\end{matrix} \\ {I}_{3} = \{ \begin{matrix}- {I}_{0} , time \leq {t}_{1} \\ 0 , time > {t}_{1}\end{matrix} \\ {I}_{4} = \{ \begin{matrix}- {I}_{0} , time \leq {t}_{2} \\ 0 , time > {t}_{2}\end{matrix}$$

I₀ represents a predetermined current magnitude, and t₁ and t₂ respectively represent a cutoff time of a positive square wave excitation and a cutoff time of a negative square wave excitation.

In addition, referring to FIG. 4, which is a waveform diagram of a single square wave excitation source in prior art provided by the present disclosure. The conventional single square wave excitation source can be expressed by the following equation.

$$I = - {I}_{5} + {I}_{6} \\ wherein , \\ {I}_{5} = \{ \begin{matrix}{I}_{0} , time \leq 0 \\ 0 , time > 0\end{matrix} {I}_{6} = \{ \begin{matrix}{I}_{0} , time \leq {t}_{1} \\ 0 , time > {t}_{1}\end{matrix}$$

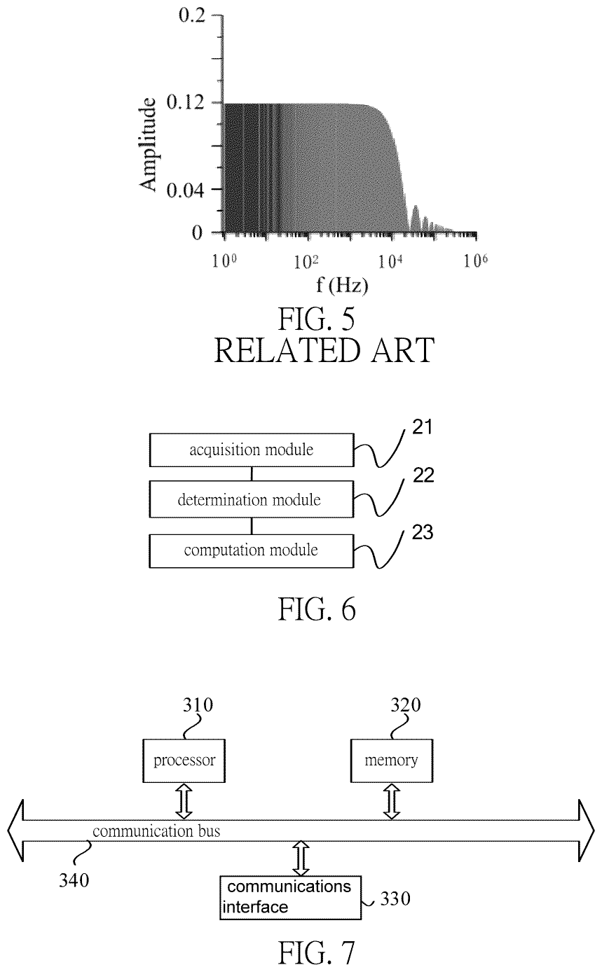

I₀ represents a predetermined current magnitude, and t₁ represents a cutoff time of an excitation source. As shown in FIG. 3, the current duration is 0.00005 seconds. FIG. 5 illustrates a schematic diagram of a magnetic field spectrum radiated by a single square wave excitation source in the prior art provided by the present disclosure. Compared to FIG. 3, the continuous anti-symmetric square wave excitation source generates a magnetic field with a narrower frequency band than the single square wave excitation source. Distinct peaks can be observed, with a peak frequency close to 100 kHz. The spectral energy is more concentrated and stronger.

Furthermore, based on the current relationship between the anti-symmetric square wave and the single square wave excitation, the magnetic field components satisfy the following relationship.

$${B}_{dif} ( t ) = {B}_{s t e p} ( t ) + 2 {B}_{s t e p} ( t + {t}_{1} ) - {B}_{s t e p} ( t + {t}_{2} )$$

B_{dif}(t) represents a magnetic field component excited by the anti-symmetric square wave, Bₛₜₑₚ(t) represents a magnetic field component excited by the conventional single square wave, and t is the observation time. t₁ and t₂ are respectively the cutoff times of the positive square wave excitation and the negative square wave excitation. Similarly, the induced electromotive forces from the different components of the two excitations also exhibit a similar relationship as follows.

$${V}_{dif} ( t ) = {V}_{s t e p} ( t ) + 2 {V}_{s t e p} ( t + {t}_{1} ) - {V}_{s t e p} ( t + {t}_{2} )$$

V_{dif}(t) represents an induced electromotive force (EMF) under the excitation of the anti-symmetric square wave, and Vₛₜₑₚ(t) represents an induced EMF under the excitation of the conventional single square wave. It should be noted that the gradient of the magnetic field with respect to time is the EMF. When the magnetic field varies over time, its rate of change (i.e., the gradient of the magnetic field with respect to time) generates an induced EMF.
Step S12: determining first magnetic field distribution information corresponding to the predetermined homogeneous model based on the first time-domain signal, and determining second magnetic field distribution information corresponding to the target stratum based on the second time-domain signal.

It should be noted that, in the electromagnetic field theory, the time-domain expression of the magnetic field can be derived using Maxwell's equations. Specifically, this involves determining the observation time range for the detection instrument and a distance between a transmitting antenna and the receiving antenna. In this context, different observation times within the observation time range correspond to different detection depths. Furthermore, based on the first time-domain signal, the observation time range, and the distance, the first magnetic field distribution information is derived using the predetermined Maxwell equations. The first magnetic field distribution information represents the magnetic field distribution of the predetermined homogeneous model at the target time and distance. The second magnetic field distribution information is derived based on the second time-domain signal, the observation time range, and the distance using the predetermined Maxwell equations. The first magnetic field distribution is the magnetic field distribution of the target stratum at the target time and the distance.

For example, Maxwell's equations in the time domain can be solved by specifying boundary conditions and initial conditions according to actual scenarios. By employing appropriate numerical methods, such as the finite element method or finite difference method, the magnetic field distribution at various observation times and positions can be calculated. Since solving time-domain electromagnetic field distributions using Maxwell's equations is a well-established technique, further elaboration is omitted.
Step S13: acquiring a full-zone apparent resistivity of the target stratum through an iterative algorithm based on the first magnetic field distribution information and the second magnetic field distribution information.

It should be noted that the full-zone apparent resistivity can more accurately reflect the conductivity information of stratums at different depths throughout the model. Specifically, this involves performing a Taylor expansion on the second magnetic field distribution information to acquire a target expression. For instance, assume that the expression of the magnetic field corresponding to the second magnetic field distribution information is B_{dif}(t, σ, r), by performing a Taylor expansion of the magnetic field expression B_{dif}(t, σ, r) at the resistivity σ₀, the target expression is obtained as follows through the Taylor expansion formula.

$${B}_{dif} ( t , σ , r ) = {B}_{dif} ( t , {σ}_{0} , r ) + {B}_{dif}^{( 1 )} ( t , σ , r ) ( σ - {σ}_{0} ) + {B}_{dif}^{( 2 )} ( t , σ , r ) {( σ - {σ}_{0} )}^{2} + O$$

σ is the apparent resistivity of the target stratum to be determined, σ₀ is the resistivity of the predetermined homogeneous model, t is the observation time, r is the distance between the transmitting antenna and the receiving antenna, B_{dif}(t, Co, r) is the first magnetic field distribution information,

$${B}_{dif}^{( 1 )} ( t , σ , r )$$

is the first-order derivative with respect to σ,

$${B}_{dif}^{( 2 )} ( t , σ , r )$$

is the second-order derivative with respect to σ, and O represents higher-order infinitesimal terms. When σ−σ₀ is sufficiently small, the second-order derivative and higher-order infinitesimal terms on the right-hand side of the equation can be omitted. Consequently, the target expression can be transformed into the following simplified form.

$$σ = {σ}_{0} + \frac{{B}_{dif} ( t , σ , r ) - {B}_{dif} ( t , {σ}_{0} , r )}{{B}_{dif}^{( 1 )} ( t , σ , r )}$$

When |σ−σ₀|<ε, the iterative algorithm stops, yielding the full-region apparent resistivity of the target stratum, wherein ε is a predetermined numerical threshold.

It should be noted that since the zz-component of the magnetic field or electromotive force is a single-valued function of resistivity, the above method can be directly applied to calculate the full-region apparent resistivity. The computational workload for calculating the full-region apparent resistivity is relatively small, enabling direct processing in downhole conditions, thus providing real-time resistivity information of the stratum. Additionally, the xx-component of the magnetic field or electromotive force is a double-valued function of resistivity and can identify signal extrema. On either side of these extrema, the signal is a single-valued function of resistivity, allowing the above method to be applied separately on both sides to determine the full-region apparent resistivity.

The embodiment of the present disclosure provides the following approach: acquiring the first time-domain signal observed by the detection instrument in a predetermined homogeneous model and the second time-domain signal observed in the target stratum, wherein the predetermined homogeneous model refers to the model with the predetermined fixed conductivity value, and the first time-domain signal and the second time-domain signal are obtained by the detection instrument corresponding to the excitation source of the anti-symmetric square wave; the current waveform corresponding to the excitation source of the anti-symmetric square wave has equal magnitude but opposite directions in positive and negative half-cycles, and the equal duration; determining the first magnetic field distribution information corresponding to the predetermined homogeneous model based on the first time-domain signal, and determining the second magnetic field distribution information corresponding to the target stratum based on the second time-domain signal; and acquiring the full-zone apparent resistivity of the target stratum through the iterative algorithm based on the first magnetic field distribution information and the second magnetic field distribution information. By leveraging the difference in duration of the antisymmetric square wave excitation sources, electromagnetic fields with different central frequencies can be excited, so as to achieve exploration of stratums at various depths. Under identical conditions, utilizing anti-symmetric square wave excitation sources with varying durations results in stronger magnetic signal intensity and higher signal-to-noise ratios and facilitates longer-range detection and enables precise exploration of distant stratum boundaries.

A device for determining a stratum apparent resistivity based on an anti-symmetric square wave is described below. The described device for determining a stratum apparent resistivity based on an anti-symmetric square wave corresponds to the method for determining a stratum apparent resistivity based on an anti-symmetric square wave as described above and can be referred to interchangeably.

FIG. 6 is schematic structural diagram of the device for determining a stratum apparent resistivity based on an anti-symmetric square wave provided by the present disclosure. As shown in FIG. 6, an embodiment of the present disclosure provides the device for determining a stratum apparent resistivity based on an anti-symmetric square wave, which includes:
an acquisition module 21, configured to acquire a first time-domain signal observed by a detection instrument in a predetermined homogeneous model and a second time-domain signal observed in a target stratum, wherein the predetermined homogeneous model refers to a model with a predetermined fixed conductivity value, and the first time-domain signal and the second time-domain signal are obtained by the detection instrument corresponding to an excitation source of the anti-symmetric square wave; a current waveform corresponding to the excitation source of the anti-symmetric square wave has equal magnitude but opposite directions in positive and negative half-cycles, and an equal duration;
a determination module 22, configured to determine first magnetic field distribution information corresponding to the predetermined homogeneous model based on the first time-domain signal, and determining second magnetic field distribution information corresponding to the target stratum based on the second time-domain signal; and
a computation module 23, configured to acquire a full-zone apparent resistivity of the target stratum through an iterative algorithm based on the first magnetic field distribution information and the second magnetic field distribution information.

It should be noted that the device provided in the embodiments of the present disclosure can achieve all the steps of the methods described in the method embodiments, and achieve the same technical effects. Therefore, this embodiment will not repeat the identical parts and beneficial effects shared with the method embodiments.

FIG. 7 is a schematic structural diagram of an electronic device provided by the present disclosure. As shown in FIG. 7, the electronic device may include: a processor 310, a memory 320, a communications interface 330, and a communications bus 340. The processor 310, the memory 320, and the communications interface 330 are interconnected via the communications bus 340. The processor 310 can invoke logical instructions stored in the memory 320 to execute the method for determining the apparent resistivity of stratums based on antisymmetric square waves.

Additionally, the logical instructions stored in the memory 320 may be implemented as software functional modules. When sold or used independently, these modules may be stored in a computer-readable storage medium. Based on this understanding, the technical solutions of the present disclosure, or the parts that contribute to the prior art, may be embodied as software products. The computer software products can be stored in storage media, such as USB drives, portable hard drives, Read-Only Memory (ROM), Random Access Memory (RAM), magnetic disks, or optical discs. These media contain multiple instructions for enabling a computer device (such as a personal computer, server, or network device) to execute all or part of the steps described in the embodiments of the present disclosure.

Furthermore, the present disclosure provides a non-transitory computer-readable storage medium storing a computer program. When executed by the processor, this computer program performs the method for determining the apparent resistivity of stratums based on antisymmetric square waves described above.

The described device embodiments are merely illustrative. The components described as separate units may or may not be physically separate. Similarly, components described as modules may or may not be physical modules; they can be located in one place or distributed across multiple network units. Parts or all of the modules can be selected to achieve the objectives of the embodiment scheme as required. Those skilled in the art can easily understand and implement these designs without creative effort.

Through the descriptions of the above embodiments, those skilled in the art will recognize that the embodiments can be implemented via software combined with essential general-purpose hardware platforms. Alternatively, they can be implemented entirely in hardware. Based on this understanding, the technical solutions of the present disclosure, or the parts contributing to the prior art, can be embodied as software products. These software products can be stored in computer-readable storage media, such as ROM, RAM, magnetic disks, or optical discs, and include instructions to enable a computer device (e.g., a personal computer, server, or network device) to execute the methods described in the various embodiments or portions thereof.

Finally, it should be stated that the embodiments described above are only for illustrating the technical solutions of the present disclosure and not for limiting them. Although the present disclosure has been described in detail with reference to the aforementioned embodiments, those skilled in the art should understand that modifications or equivalent replacements of the technical solutions described in the embodiments can still be made. Such modifications or replacements do not deviate from the essence of the technical solutions described in the embodiments of the present disclosure.

What is claimed is:

1. A method for determining a stratum apparent resistivity based on an anti-symmetric square wave, comprising:
acquiring a first time-domain signal observed by a detection instrument in a predetermined homogeneous model and a second time-domain signal observed in a target stratum, wherein the predetermined homogeneous model refers to a model with a predetermined fixed conductivity value, and the first time-domain signal and the second time-domain signal are obtained by the detection instrument observing an excitation source of the anti-symmetric square wave; a current waveform corresponding to the excitation source of the anti-symmetric square wave has equal magnitude but opposite directions in positive and negative half-cycles, and an equal duration;
determining first magnetic field distribution information corresponding to the predetermined homogeneous model based on the first time-domain signal, and determining second magnetic field distribution information corresponding to the target stratum based on the second time-domain signal; and
acquiring a full-zone apparent resistivity of the target stratum through an iterative algorithm based on the first magnetic field distribution information and the second magnetic field distribution information.

2. The method for determining a stratum apparent resistivity based on an anti-symmetric square wave according to claim 1, wherein a current expression of the excitation source of the anti-symmetric square wave is as follows:
$$I = - {I}_{1} + {I}_{2} - {I}_{3} + {I}_{4} \\ {I}_{1} = \{ \begin{matrix}{I}_{0} , time \leq 0 \\ 0 , time > 0\end{matrix} {I}_{2} = \{ \begin{matrix}{I}_{0} , time \leq {t}_{1} \\ 0 , time > {t}_{1}\end{matrix} \\ {I}_{3} = \{ \begin{matrix}- {I}_{0} , time \leq {t}_{1} \\ 0 , time > {t}_{1}\end{matrix} \\ {I}_{4} = \{ \begin{matrix}- {I}_{0} , time \leq {t}_{2} \\ 0 , time > {t}_{2}\end{matrix} \\ or \\ I = {I}_{1} - {I}_{2} + {I}_{3} - {I}_{4} \\ {I}_{1} = \{ \begin{matrix}{I}_{0} , time \leq 0 \\ 0 , time > 0\end{matrix} {I}_{2} = \{ \begin{matrix}{I}_{0} , time \leq {t}_{1} \\ 0 , time > {t}_{1}\end{matrix} \\ {I}_{3} = \{ \begin{matrix}- {I}_{0} , time \leq {t}_{1} \\ 0 , time > {t}_{1}\end{matrix} \\ {I}_{4} = \{ \begin{matrix}- {I}_{0} , time \leq {t}_{2} \\ 0 , time > {t}_{2}\end{matrix}$$
wherein I₀ represents a predetermined current magnitude, and t₁ and t₂ respectively represent a cutoff time of a positive square wave excitation and a cutoff time of a negative square wave excitation.

3. The method for determining a stratum apparent resistivity based on an anti-symmetric square wave according to claim 1, wherein determining first magnetic field distribution information corresponding to the predetermined homogeneous model based on the first time-domain signal, and determining second magnetic field distribution information corresponding to the target stratum based on the second time-domain signal, includes:
determining an observation time range of the detection instrument and a distance between a transmitting antenna and a receiving antenna, wherein different observation times within the observation time range correspond to different detection depths;
acquiring the first magnetic field distribution information based on the first time-domain signal, the observation time range, and the distance by using a predetermined Maxwell's equations group, wherein the first magnetic field distribution information refers to magnetic field distribution of the predetermined homogeneous model at a target time and the distance;
acquiring the second magnetic field distribution information based on the second time-domain signal, the observation time range, and the distance by using the predetermined Maxwell's equations group, wherein the second magnetic field distribution information refers to magnetic field distribution of the target stratum at the target time and the distance.

4. The method for determining a stratum apparent resistivity based on an anti-symmetric square wave according to claim 3, wherein acquiring a full-zone apparent resistivity of a target stratum through an iterative algorithm based on the first magnetic field distribution information and the second magnetic field distribution information includes:
determining a resistivity of the predetermined homogeneous model;
performing a Taylor expansion on the second magnetic field distribution information to acquire a target expression;
acquiring the full-zone apparent resistivity of the target stratum through the iterative algorithm based on the resistivity, the first magnetic field distribution information, the second magnetic field distribution information, and the target expression.

5. The method for determining a stratum apparent resistivity based on an anti-symmetric square wave according to claim 4, wherein the target expression is as follows:
$${B}_{dif} ( t , σ , r ) = {B}_{dif} ( t , {σ}_{0} , r ) + {B}_{dif}^{( 1 )} ( t , σ , r ) ( σ - {σ}_{0} ) + {B}_{dif}^{( 2 )} ( t , σ , r ) {( σ - {σ}_{0} )}^{2} + O$$
wherein σ represents an apparent resistivity to be determined in the target stratum, σ₀ represents the resistivity of the predetermined homogeneous model, t represents the observation time, r represents the distance between the transmitting antenna and the receiving antenna, B_{dif}(t, σ₀, r) refers to the first magnetic field distribution information,
$${B}_{dif}^{( 1 )} ( t , σ , r )$$
denotes a first-order derivative,
$${B}_{dif}^{( 2 )} ( t , σ , r )$$
denotes a second-order derivative, and O represents a higher-order infinitesimal term, and wherein
by transforming the target expression, a resultant form of the expression is as follows:
$$σ = {σ}_{0} + \frac{{B}_{dif} ( t , σ , r ) - {B}_{dif} ( t , {σ}_{0} , r )}{{B}_{dif}^{( 1 )} ( t , σ , r )}$$
wherein, when |σ−σ₀|<ε, the iterative algorithm stops, and the full-zone apparent resistivity of the target stratum is determined, wherein ε is a predetermined numerical threshold.

6. A device for determining a stratum apparent resistivity based on an anti-symmetric square wave, comprising:
an acquisition module, configured to acquire a first time-domain signal observed by a detection instrument in a predetermined homogeneous model and a second time-domain signal observed in a target stratum, wherein the predetermined homogeneous model refers to a model with a predetermined fixed conductivity value, and the first time-domain signal and the second time-domain signal are obtained by the detection instrument observing an excitation source of the anti-symmetric square wave; a current waveform corresponding to the excitation source of the anti-symmetric square wave has equal magnitude but opposite directions in positive and negative half-cycles, and an equal duration;
a determination module, configured to determine first magnetic field distribution information corresponding to the predetermined homogeneous model based on the first time-domain signal, and determine second magnetic field distribution information corresponding to the target stratum based on the second time-domain signal; and
a computation module, configured to acquire a full-zone apparent resistivity of the target stratum through an iterative algorithm based on the first magnetic field distribution information and the second magnetic field distribution information.
